(19) United States
(12) Patent Application Publication
(10) Pub. No.: US 2010/0310961 A1
(43) Pub. Date: Dec. 9, 2010

(54) Integratable and Scalable Solid Oxide Fuel Cell Structure and Method of Forming

(75) Inventor: Robert Daniel Clark, Livermore, CA (US)

Correspondence Address: Robert D. Clark, 5812 Edelweiss Way, Livermore, CA, 94551, US

(73) Assignee: Dr. Robert Daniel Clark, Schenectady, NY (US)

(21) Appl. No.: 12/792,755

(22) Filed: Jun. 3, 2010

Related U.S. Application Data
(60) Provisional application No. 61/184,785, filed on Jun. 6, 2009.

(51) Int. Cl. H01M 8/24; H01M 8/00; H01M 4/02; H01M 8/02; B05D 5/12; H01M 8/10

(52) U.S. Cl. 429/452; 429/535; 429/523; 429/514; 427/115

(57) ABSTRACT

A method of forming a fuel cell pile including a porous anode and a porous cathode separated by a dense electrolyte is disclosed. A solid oxide fuel cell incorporating the fuel cell pile is formed on a substrate by a series of lithography, etch and deposition steps that create a solid oxide fuel cell. Individual cells may be interconnected by micro-channels and metal interconnects to form fuel cell stacks. The structure of the cell and a method of manufacturing are disclosed.

### PRIOR PROVISIONAL APPLICATION

This application claims the benefit of the filing date of U.S. Provisional Application No. 61/184,785, filed Jun. 6, 2009 and entitled “Integratable and Scalable Solid Oxide Fuel Cell Structure and Method of Forming”

### FIELD OF INVENTION

The present invention relates to the field of solid oxide fuel cells and more specifically to the field of forming highly scaled micro-solid oxide fuel cells using monolithic integration methods.

### BACKGROUND OF THE INVENTION

Solid Oxide Fuel Cells (SOFC's) generate electricity by electrochemical oxidation of a fuel using oxygen or air as an oxidant. The oxidant contacts a permeable cathode that catalytically reduces oxygen to O²⁻ ions. The O²⁻ ions then pass through an electrolyte that is impermeable to most gasses, including oxygen and nitrogen, but has a high conductivity of oxygen anions to the permeable anode where is it catalytically reacted with the fuel releasing electrons. By connecting the anode and the cathode electrically and providing a load, usable electrical energy is created. FIG. 1 is a schematic representation of a SOFC showing an example reaction.

Two main geometries for SOFC's have been used in the past. The Planar geometry shown schematically in FIG. 2 consists of a series of plates that are stacked together to form the fuel cell. The tubular geometry shown is FIG. 3 is created when the cathode, electrolyte and anode are molded around a central tube where the oxidant flows.

Because a single SOFC produces relatively little electrical power, fuel cells are generally connected together in series in order to increase the power output to usable levels. FIG. 4 shows a historic example of such a fuel cell stack, and FIG. 5 shows a more recent example of a tubular SOFC stack produced by Siemens.

In the past, SOFC's have suffered from several limitations. They require high temperatures to operate (>500 C), so their materials of construction must by very thermally robust, and normal metal interconnects of Al or Cu, for example cannot be used inside SOFC stacks. They also have relatively low efficiency and lower power density when compared with combustion engines.

One recent trend has been the formation of micro-SOFC's as small as about 1 mm across in the case of a tubular SOFC. There are several advantages to making SOFC's smaller. It is possible to fit more of them into a given area, and thus to realize higher power densities. The fuel cell is smaller and therefore more portable. The smaller size uses a thinner electrolyte, so oxygen conductivity is increased leading to more efficient operation at a lower operating temperature. And the relaxed temperature requirement allows the use of materials that are not as thermally robust.

Membrane-type micro-SOFC's have shown particular promise (for example, see A. Evans, et al., J. Power Sources (2009), doi:10.1016/j.jpowsour.2009.03.048). By increasing the active area and decreasing the thickness of the electrolyte it is possible to realize acceptable power densities at relatively low temperatures (350-500 C). However, the need to produce a free standing membrane in this type of cell poses obvious structural concerns with respect to cracking or damage to the membrane from shocks, falls or vibrations in real world situations. In addition the manufacturing processes used for current micro-SOFC's require the use of lift-off or backside etch techniques that are difficult to implement in a low-cost high volume manufacturing scheme.

Accordingly, further developments are required to solve these and other problems associated with manufacturing micro-SOFC's.

### PROBLEMS SOLVED BY THIS INVENTION

This invention provides a new architecture for the production of micro-SOFC's. In this case it makes use of techniques developed over many years for integrated circuit manufacturing on semiconducting substrates, such as Si. It also takes advantage of micro-channels that have been put in use for MEMS and biotech applications recently, and can allow the transport of gases to and from the cell. By developing a cell structure that can be integrated in a bottom up monolithic fashion it is possible to manufacture these cells on a variety of substrates without developing new handling techniques for production. In addition, this manufacturing scheme and architecture makes it possible to integrate these devices within integrated circuits or to integrate them with MEMS structures in the future. Finally because the architecture does not rely on a free-standing membrane, this structure is expected to be more structurally robust than current membrane type micro-SOFC's while maintaining the performance advantages of a thin, high area electrolyte that they provide.

### SUMMARY OF THE INVENTION

A Method is provided for forming a fuel cell pile that is integratable in a device using a monolithic integration scheme.

According to an embodiment of the invention there is provided a solid oxide fuel cell pile that is formed in a well in a substrate and consisting of a porous cathode and a porous anode separated by an electrolyte. Each fuel cell is contacted by a micro-channel for fuel flow and a micro-channel for oxidant flow. And the fuel cells are also contacted electrically by interconnect wiring at the anode and cathode. The use of a well-type structure is illustrative and not intended to be limiting. It will be apparent to one skilled in the art that other geometries are possible according to this process, such as a stacked cup geometry or trench-type geometry. In one embodiment of the invention the fuel cell is only contacted by a micro-channel for fuel flow, and the cathode of the fuel cell is left open to be contacted by air. It is envisioned that external packaging may be required to operate the fuel cell and to provide it with heat, fuel and oxidant. Such packaging is already known to those skilled in the art and not described in detail.

According to another embodiment of the invention a method is provided for the formation of the fuel cell on a planar substrate using lithography, etching and deposition techniques commonly applied in the manufacture of integrated circuits (IC's) or in the manufacture of micro-electromechanical machines (MEMS). According to this aspect of the invention the diameter of the wells or tubes for the SOFC is lithographically defined to be less than about 5 mm wide and preferably less than about 2000 microns in diameter.

According to another embodiment of the invention a method is provided for manufacturing of the device without the use of lift-off or backside etching techniques. It is envisioned that the fuel cells produced by this invention may be integrated with IC's, MEMS or some other related technology, and such integration, may in the future require or make use of 3 dimensional integration techniques such as chip stacking. In particular it is envisioned that integration with power-harvesting technologies such as piezoelectric power generators that make use of the heat generated from the fuel cells would be beneficial. And that integration with MEMS for fuel controls, or IC's that control or make use of the power produced by the cell would be beneficial as well.

According to another embodiment of the invention a porous dielectric support layer is used for the anode and cathode. The porous dielectric support layer may for instance consist of essentially SiO₂. The porous dielectric layer may further be deposited using for example a CVD, PECVD or spin-on deposition process incorporating a Si-containing precursor and an organic pore forming agent. The organic pore forming agent may be incorporated into the film as deposited as an oligomeric or polymeric material that is removed by subsequent treatments to create a porous dielectric structure. In another embodiment of the invention the porous dielectric support can be made of a group 4 or Rare Earth or Alkaline Earth based elements or mixtures thereof. In that case a porogen may also be used in order to increase the porosity of the dielectric layer. In some embodiments the porous dielectric support may be coated with an electrolyte material in order to increase the triple phase boundary length of the device. In another embodiment the porous dielectric support layer may be substantially composed of an electrolyte material that may or may not be the same material as the dense electrolyte film. It is envisioned that the porous dielectric support layers for the anode and the cathode may not be made of the same material or may be optimized differently. The discussion of the porous support layers is not meant to limit this invention to use of the same material for the anode and the cathode supports.

According to another embodiment of the invention the porous support dielectrics are infused with catalytically active cathode and anode materials. Such catalytic materials may be for instance Ni, Pt, Pd, Ru, Rh, Ir, Pd or mixtures thereof. According to one aspect of the invention the porous support materials are infused with the catalytically active anode and cathode materials in a vapor phase infusion. One example of a vapor phase process useful for such an infusion is atomic layer deposition (ALD). Other catalytic materials may be used as well, such as cermet materials. The materials listed in this disclosure are illustrative and not meant to be limiting.

According to another embodiment of the invention a dense electrolyte is used to separate the cathode and anode and allow the conduction of ions from one side to the other. The dense electrolyte may be a good conductor of oxygen ions, such as yttria stabilized zirconia (YSZ) or cerium gadolinium oxide (CGO). In another embodiment the electrolyte might act as a proton exchange membrane and may be formed from barium and yttrium doped zirconia, for instance. The materials mentioned herein are provided as examples and not meant to be limiting.

According to another embodiment of the invention an electrical interconnect to the fuel cell is formed. In one embodiment the interconnect may be formed of a metal, such as Al or Cu. In another embodiment the interconnect may be a conducting ceramic material.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 schematically shows a cross-sectional view of a fuel cell pile according to embodiments of the invention;

FIG. 2 schematically shows a cross-sectional view of an integrated fuel cell structure formed according to embodiments of the invention;

FIG. 3 schematically shows a cross-sectional view of an integrated fuel cell structure for use with air oxidation formed according to embodiments of the invention;

FIGS. 4A-D Provide an illustrated outline of the steps used in fabricating an integrated fuel cell structure according to embodiments of the invention

### DETAILED DESCRIPTION OF SEVERAL EMBODIMENTS

Methods or forming fuel cell structures amenable to monolithic integration are presented herein. According to an embodiment of the invention a fuel cell pile is formed consisting of a porous anode, a dense electrolyte and a porous cathode. The porous anode is formed by infusing a porous dielectric layer with a catalytic anode material. Similarly the porous cathode is formed by infusing a porous dielectric layer with a catalytic cathode material. Methods of forming the porous anode and porous cathode are described herein. Methods of forming the dense electrolyte are also provided.

The invention further includes a monolithic process for forming an integrated fuel cell structure incorporating the fuel cell pile formed according to embodiments of the invention.

One skilled in the relevant art will recognize that the various embodiments may be practiced without one or more of the specific details described herein, or with other replacement and/or additional methods, materials, or components. In other instances, well-known structures, materials, or operations are not shown or described in detail herein to avoid obscuring aspects of various embodiments of the invention. Similarly, for purposes of explanation, specific numbers, materials, and configurations are set forth herein in order to provide a thorough understanding of the invention. Furthermore, it is understood that the various embodiments shown in the figures are illustrative representations and are not necessarily drawn to scale.

Reference throughout this specification to “one embodiment” or “an embodiment” means that a particular feature, structure, material, or characteristic described in connection with the embodiment is included in at least one embodiment of the invention, but does not denote that they are present in every embodiment. Thus, the appearances of the phrases “in one embodiment” or “in an embodiment” in various places throughout this specification are not necessarily referring to the same embodiment of the invention.

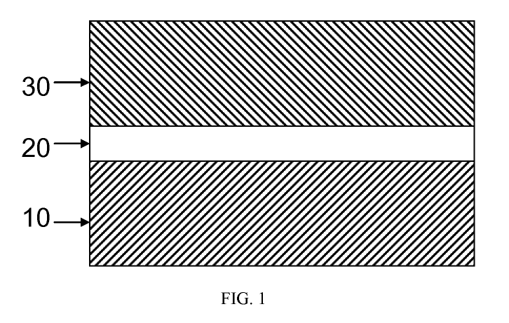

FIG. 1 schematically shows a cross-sectional view of a fuel cell pile according to embodiments of the invention. The fuel cell pile consists of a porous anode layer 10, contacted by a dense electrolyte 20, which is in turn contacted by a porous cathode layer 30. This figure is illustrative and not meant to imply any preferred orientation or geometry of the fuel cell pile, but to illustrate the organization of the fuel cell pile as having a dense electrolyte 20 formed between the porous anode 10 and the porous cathode 30 layers. It will be recognized by one skilled in the art that the fuel cell pile may be vertically oriented or oriented at any angle. It will further be recognized that the fuel cell pile might be formed over a 3 dimensional structure. In one preferred embodiment the fuel cell is formed in a trench or well that has been etched in supporting dielectric layers on a substrate. In another preferred embodiment the fuel cell pile is deposited on a cup type structure.

The porous anode layer 10 may in one embodiment be formed by infusing a porous dielectric layer with a catalytically active anode material. The anode material may comprise Pt, Pd, Rh, Ir, Ru, Ni or Os or mixtures thereof. The anode material may comprise one or more transition metals. In one preferred embodiment the anode material comprises Pt. The infusing of the porous dielectric layer is preferably performed by a vacuum deposition process. Vacuum deposition processes include chemical vapor deposition, physical vapor deposition or atomic layer deposition type processes. In one preferred embodiment the porous dielectric layer is infused with the catalytically active anode material by atomic layer deposition.

The porous dielectric support layer of the porous anode layer 10 may be formed by depositing a dense layer containing a porogen and then removing the porogen by a thermal, UV, plasma or other treatment. The porous dielectric layer may comprise Si. In one embodiment, the porous dielectric support layer is porous SiO₂. In another preferred embodiment the porous dielectric layer is formed by depositing a layer comprising Si and a porogen by plasma enhanced chemical vapor deposition or by spin on deposition and then removing the porogen from the film to form porous dielectric layer comprise substantially of SiO₂. In another preferred embodiment the porous dielectric layer is porous alumina.

In another preferred embodiment the porous anode layer 10 may be infused with an electrolyte layer in addition to a catalytically active anode material.

The dense electrolyte layer 20 is used to transfer oxygen ions or hydrogen ions between the anode and the cathode during operation of the fuel cell. The dense electrolyte layer may for instance comprise Zr, Hf, Ba, Sr, Y, La or mixtures thereof. In another embodiment the dense electrolyte comprises a Lanthanide or rare earth metal or a mixture thereof. In one preferred embodiment the dense electrolyte layer 20 is comprised substantially of yttria-stabilized zirconia. In another preferred embodiment the dense electrolyte layer 20 is comprised of Y and Ba doped zirconia. In another preferred embodiment the dense electrolyte layer 20 is comprised of cerium gadolinium oxide.

The dense electrolyte layer 20 is preferably formed in a vapor deposition process such as chemical vapor deposition, physical vapor deposition or atomic layer deposition type processes. In one preferred embodiment the dense electrolyte layer 20 is formed by atomic layer deposition.

The porous cathode layer 30 may in one embodiment be formed by infusing a porous dielectric layer with a catalytically active cathode material. The cathode material may comprise Pt, Pd, Rh, Ir, Ru, Ni or Os or mixtures thereof. The cathode material may comprise one or more transition metals. In one preferred embodiment the cathode material comprises Pt. The infusing of the porous dielectric layer is preferably performed by a vacuum deposition process. Vacuum deposition processes include chemical vapor deposition, physical vapor deposition or atomic layer deposition type processes. In one preferred embodiment the porous dielectric layer is infused with the catalytically active cathode material by atomic layer deposition.

The porous dielectric support layer of the porous cathode layer 30 may be formed by depositing a dense layer containing a porogen and then removing the porogen by a thermal, UV, plasma or other treatment. The porous dielectric layer may comprise Si. In one embodiment, the porous dielectric support layer is porous SiO₂. In another preferred embodiment the porous dielectric layer is formed by depositing a layer comprising Si and a porogen by plasma enhanced chemical vapor deposition or by spin on deposition and then removing the porogen from the film to form porous dielectric layer comprise substantially of SiO₂. In another preferred embodiment the porous dielectric layer is porous alumina.

In another preferred embodiment the porous cathode layer 30 may be infused with an electrolyte layer in addition to a catalytically active cathode material.

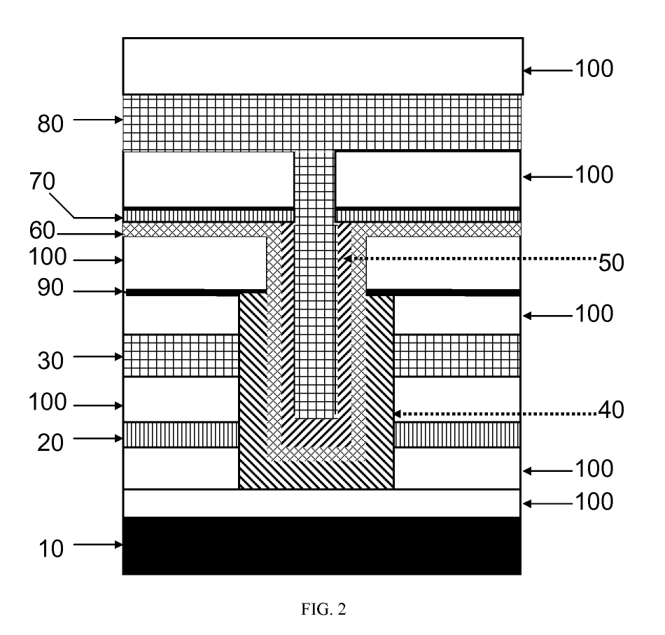

One preferred embodiment of the present invention is shown in FIG. 2 which illustrates schematically a cup or well-type fuel cell incorporating the fuel cell pile described above. The fuel cell is formed on a substrate 10, and supported by several support layers 100. The support layers may be dielectrics. In one preferred embodiment the support layers are each selected from silicon oxide, silicon nitride, doped silicon oxide, doped silicon oxide, or silicon carbide and mixtures thereof. The fuel cell is comprised of microchannels for the fuel 30 and oxidant 80. The fuel cell may further be comprised of one or more etch stop or barrier layers used in integrating the fuel cell structure. The fuel cell pile in FIG. 2 is comprised of a porous anode 40 and porous cathode 50 separated by a dense electrolyte 60. In addition the fuel cell in FIG. 2 comprises conducting interconnect layers 20 and 70 to the anode and cathode respectively.

The microchannels 30 and 80 are lithographically defined and may be formed by depositing a sacrificial layer that is then removed by a thermal or etching process. The interconnect layers 20 and 70 may comprise W, Al, Cu, Co, Ru, Pt, Pd, Ni or mixtures thereof.

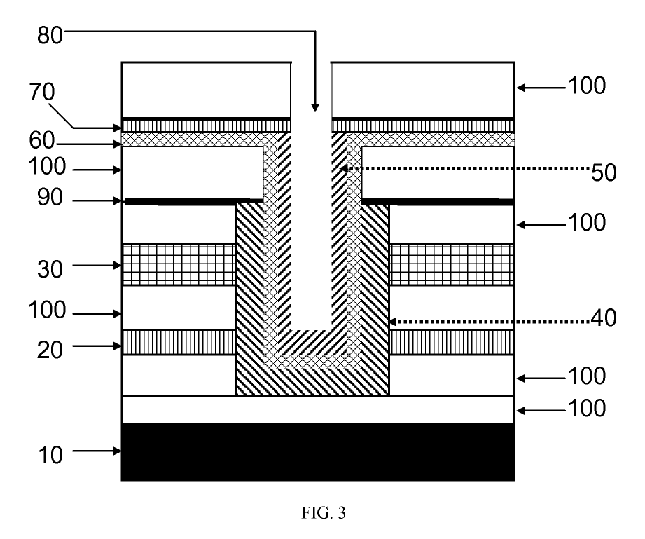

Another preferred embodiment of the present invention is shown in FIG. 3 which illustrates schematically a cup or well-type fuel cell incorporating the fuel cell pile described above. The fuel cell is formed on a substrate 10, and supported by several support layers 100. The support layers may be dielectrics. In one preferred embodiment the support layers are each selected from silicon oxide, silicon nitride, doped silicon oxide, doped silicon oxide, or silicon carbide and mixtures thereof. The fuel cell is comprised of a microchannel for the fuel 30 and a well for air contact to the cathode 80. The fuel cell may further be comprised of one or more etch stop or barrier layers used in integrating the fuel cell structure. The fuel cell pile in FIG. 3 is comprised of a porous anode 40 and porous cathode 50 separated by a dense electrolyte 60. In addition the fuel cell in FIG. 3 comprises conducting interconnect layers 20 and 70 to the anode and cathode respectively.

The microchannel 30 is lithographically defined and may be formed by depositing a sacrificial layer that is then removed by a thermal or etching process. The interconnect layers 20 and 70 may comprise W, Al, Cu, Co, Ru, Pt, Pd, Ni or mixtures thereof.

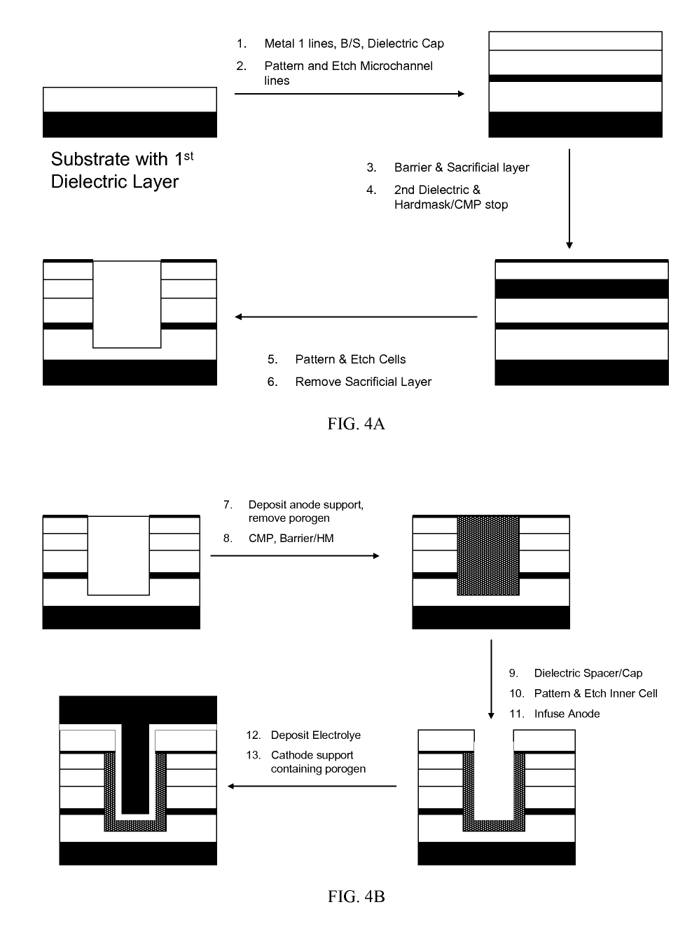

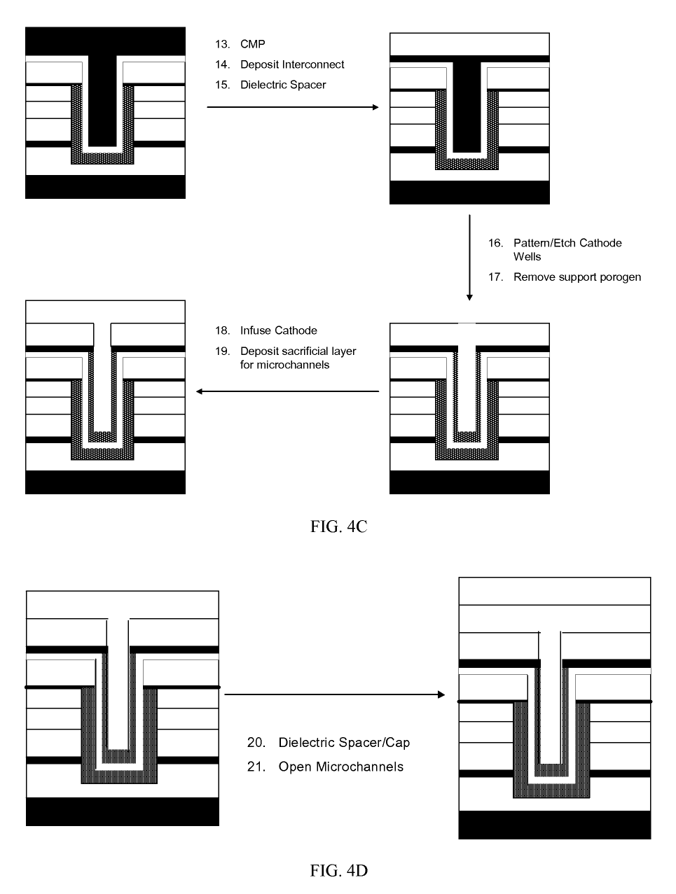

FIGS. 4A-D illustrate a series of steps that one skilled in the art will recognize as being useful in forming a fuel cell structure according to this invention. These diagrams are illustrative and not meant to be limiting as to the number, order or nature of the steps performed in forming the fuel cell. One skilled in the art will recognize that different sequences might be used to form a fuel cell according to this invention, and that additional steps may be beneficial in constructing the fuel cell. For instance several cleaning and ashing steps that are obvious to those skilled in the art have been omitted FIGS. 4A-D illustrate the formation of a single fuel cell, but it is envisioned that more than one fuel cell may be formed simultaneously by this method. In one preferred embodiment an array of fuel cells is formed on a single substrate. In another preferred embodiment several arrays of fuel cells are formed on a single substrate by methods commonly used in microchip or micro-electromechanical machine fabrication.

FIG. 4A illustrates starting with a substrate or an area of the substrate and a first dielectric layer. In step 1 Barrier/Seed layers and Metal lines are then deposited and defined by lithography and etching. A barrier layer is deposited and a dielectric cap is deposited. In step 2 microchannel lines are patterned in the dielectric by lithography and etching. In step 3 a barrier layer is then deposited and a sacrificial layer is deposited and planarized. In step 4 another dielectric spacer is added and a hardmask and CMP stop is then deposited. The cells are then patterned and etched in step 5, followed by removing the sacrificial layer in step 6.

FIG. 4B step 7 illustrates depositing the anode support layer and removing the porogen from the layer to form a porous dielectric support layer, followed by CMP to planarize, and barrier and/or hard mask deposition in step 8. Step 9 illustrates depositing a spacer or cap layer. In step 10 the inner cell is patterned lithographically and etched. In step 11 the anode layer is infused with the catalytically active anode material. In step 12 the dense electrolyte layer is deposited and then in step 13 the cathode support layer is deposited on top of the dense electrolyte.

In FIG. 4C step 13 is CMP planarization followed by depositing patterning an interconnect layer in step 14. Barrier layers may be incorporated before, after or before and after step 14. Step 15 illustrates depositing another dielectric spacer layer that is patterned and etched in step 16. The cathode support porogen is removed in step 17 and the cathode is infused with the catalytically active cathode material in step 18. In step 19 a sacrificial layer for oxidant microchannels is deposited and defined by lithography and etching.

In FIG. 4D step 20 a dielectric spacer or cap is deposited and planarized. The microchannels are then opened in step 21 after they are connected to the global fuel microchannels of the integrated fuel cell.

It will be recognized by one skilled in the art that arrays of fuel cells may be formed according to this invention, and that those arrays may require global interconnect, and fuel and oxidant microchannels with global connections as well. The term global is meant in the general sense of providing a connection to systems or structures outside of the individual fuel cell.

A plurality of embodiments for forming a fuel cell have been disclosed in various embodiments. The foregoing description of the embodiments of the invention has been presented for the purposes of illustration and description. It is not intended to be exhaustive or to limit the invention to the precise forms disclosed. This description and the claims following include terms that are used for descriptive purposes only and are not to be construed as limiting. For example, the term “on” as used herein (including in the claims) does not require that a film “on” a substrate is directly on and in immediate contact with the substrate; there may be a second film or other structure between the film and the substrate.

Persons skilled in the relevant art can appreciate that many modifications and variations are possible in light of the above teaching. Persons skilled in the art will recognize various equivalent combinations and substitutions for various components shown in the Figures. It is therefore intended that the scope of the invention be limited not by this detailed description, but rather by the claims appended hereto.

What is claimed is:

1. A process for forming a fuel cell pile consisting of a porous anode and a porous cathode separated by a dense electrolyte wherein the porous anode or cathode is formed by infusing a porous dielectric support layer with a catalytically active material in a vapor phase deposition process

2. A fuel cell device incorporating a fuel cell pile formed according to the process of claim 1

3. The process of claim 1 wherein the vapor phase deposition process used for infusing the anode or cathode is an atomic layer deposition process

4. The process of claim 1 wherein the porous dielectric support layer is formed in a spin-on or vapor phase deposition process

5. The process of claim 4 further incorporating the use of a porogen or pore forming agent during the deposition

6. The process of claim 5 wherein the as deposited layer is a dense film and undergoes subsequent thermal or irradiation treatments to remove the reacted or incorporated porogen or pore forming agents resulting in a porous dielectric support layer

7. The process of claim 1 wherein the dielectric support layer is a porous SiO₂ layer

8. The process of claim 1 wherein the porous dielectric support layer is a porous metal oxide or silicate or mixture thereof.

9. The process of claim 1 wherein the dense electrolyte is deposited in a vapor phase deposition process

10. The process of claim 9 wherein the vapor phase deposition process is a PVD, CVD or ALD process

11. The process of claim 1 wherein the dense electrolyte is a group 2, group 3, group 4 or rare earth metal oxide or a mixture thereof

12. The process of claim 1 wherein the dense electrolyte is yttria-stabilized zirconia

13. The process of claim 1 wherein the dense electrolyte is cerium gadolinium oxide

14. The process of claim 1 wherein the dense electrolyte is barium and yttrium doped zirconia

15. The process of claim 1 wherein the dense electrolyte is less than about 500 nm in thickness

16. A device according to claim 2 formed in a bottom up manufacturing scheme with lithographically define fuel cell structures

17. A device according to claim 2 that includes contacted the porous anode or cathode with one or more micro-channels in order to deliver a fuel or oxidant to the fuel cell

18. A device according to claim 2 that in which the porous cathode and porous anode are contacted by a conductive electrical interconnect that is lithographically defined

19. A fuel cell stack in which multiple devices according to claim 2 are formed together in a monolithic manufacturing process

20. A fuel cell stack according to claim 19 in which the multiple devices a interconnected electrically with lithographically defined conductive lines and connected to a fuel or oxidant source by microchannels.
